(19) United States
(12) Patent Application Publication
(10) Pub. No.: US 2026/0129405 A1
(43) Pub. Date: May 7, 2026

(54) COMMUNICATION SYSTEM, AND METHOD

(71) Applicant: KABUSHIKI KAISHA TOSHIBA, Tokyo (JP)

(72) Inventors: Yasuyuki TANAKA, Kawasaki (JP); Hiroki KUDO, Kawasaki (JP)

(73) Assignee: KABUSHIKI KAISHA TOSHIBA, Tokyo (JP)

(21) Appl. No.: 19/266,201

(22) Filed: Jul. 11, 2025

(30) Foreign Application Priority Data
Nov. 7, 2024 (JP) 2024-195326

(51) Int. Cl. H04W 4/029; H04B 17/318

(52) U.S. Cl. CPC H04W 4/029; H04B 17/318

(57) ABSTRACT

A communication includes a plurality of control devices that are disposed in the vicinity of a plurality of devices and are configured to control the plurality of devices, and a terminal device that moves in a space in which the plurality of devices are installed and is configured to perform wireless communication with the plurality of control devices. Each of the plurality of control devices periodically transmits device identification information for identifying a device controlled by the control device. When the terminal device receives the device identification information transmitted from one of the plurality of control devices, the terminal device acquires position information indicating a position of the terminal device, and transmits the received device identification information and the acquired position information.

### CROSS-REFERENCE TO RELATED APPLICATION(S)

This application is based upon and claims the benefit of priority from Japanese Patent Application No. 2024-195326, filed Nov. 7, 2024, the entire contents of which are incorporated herein by reference.

### FIELD

Embodiments described herein relate generally to a communication system and method.

### BACKGROUND

In general, it is known to control a plurality of devices to achieve an object such as energy saving, but in order to realize control of the plurality of devices, a time-consuming operation may be required.

### BRIEF DESCRIPTION OF THE DRAWINGS

FIG. 1 is a diagram for explaining control of an lighting apparatus in a first comparative example.

FIG. 2 is a diagram for explaining a communication system according to a second comparative example.

FIG. 3 is a block diagram showing an example of a functional configuration of a terminal device.

FIG. 4 is a diagram showing an example of a hardware configuration of a terminal device.

FIG. 5 is a block diagram showing an example of a functional configuration of a control device.

FIG. 6 is a diagram for explaining a specific aspect of a lighting apparatus.

FIG. 7 is a flowchart showing an example of a processing procedure of the communication system.

FIG. 8 is a diagram for explaining an example of a process of registering setting information.

FIG. 9 is a diagram for explaining another example of the process of registering the setting information.

FIG. 10 is a diagram showing an example of a data structure of setting information.

FIG. 11 is a diagram showing an example of a data structure of data transmitted from a terminal device.

FIG. 12 is a diagram for explaining an overview of a communication system according to the present embodiment.

FIG. 13 is a flowchart showing an example of a processing procedure of the communication system.

FIG. 14 is a diagram for explaining an example of a configuration using a user management system.

FIG. 15 is a diagram for explaining another example of a configuration using the user management system.

FIG. 16 is a diagram for explaining a configuration in which sensor data is transmitted from a control device.

FIG. 17 is a diagram showing an example of arrangement of a number of lighting apparatuses.

FIG. 18 is a diagram for specifically explaining installation positions of lighting apparatuses registered in the remote control system.

FIG. 19 is a diagram for specifically explaining installation positions of lighting apparatuses registered in the remote control system.

FIG. 20 is a diagram for specifically explaining installation positions of lighting apparatuses registered in the remote control system.

FIG. 21 is a diagram for specifically explaining installation positions of lighting apparatuses registered in the remote control system.

FIG. 22 is a diagram for specifically explaining installation positions of lighting apparatuses registered in the remote control system.

FIG. 23 is a diagram for specifically explaining installation positions of lighting apparatuses registered in the remote control system.

### DETAILED DESCRIPTION

In general, according to an embodiment, a communication system includes a plurality of control devices arranged in the vicinity of a plurality of devices and configured to control the plurality of devices, and a terminal device configured to move in a space where the plurality of devices are installed and perform wireless communication with the plurality of control devices. According to one implementation, the term “in the vicinity of” means in the same room. According to another implementation, “in the vicinity of” means one the same floor. According to yet another implementation, “in the vicinity of”means in the same building. According to still another implementation, in the vicinity of means that there is a predetermined signal strength between the relevant devices, for example, a Bluetooth or Wi-Fi signal. Still further, according to another implementation, “in the vicinity of” means within a predetermined distance. Each of the plurality of control devices transmits device identification information for identifying a device controlled by the control device at a predetermined interval. When the terminal device receives the device identification information transmitted from one of the plurality of control devices, the terminal device acquires position information indicating a position of the terminal device, and transmits the received device identification information and the acquired position information.

Hereinafter, embodiments will be described with reference to the drawings. In the present embodiment, a communication system used for providing a service for controlling a device will be described, and a lighting apparatus installed in a building, or the like is assumed as the device, for example.

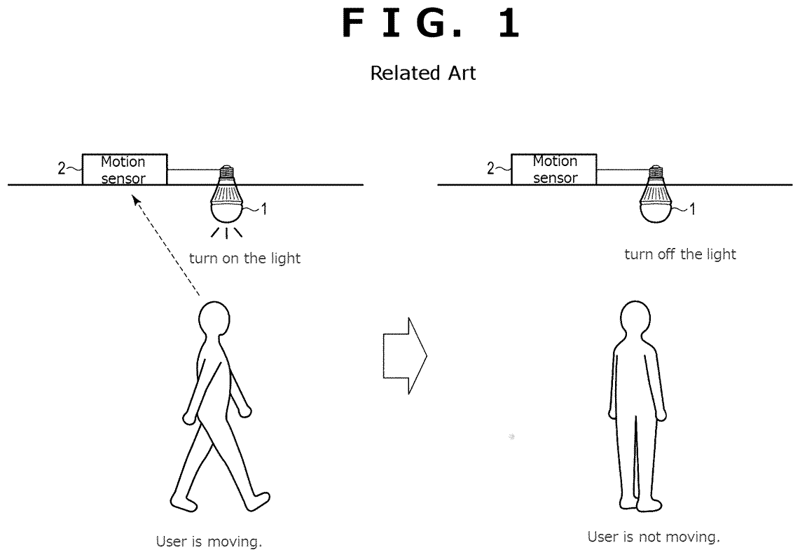

Here, control of a lighting apparatus assumed in a first comparative example of the present embodiment will be described with reference to FIG. 1.

In the first comparative example, for example, a motion sensor 2 is installed in the vicinity of the lighting apparatus 1, and the motion sensor 2 is connected to the lighting apparatus 1. The motion sensor 2 is configured to detect a motion of a person (that is, a user) in the vicinity of the motion sensor 2 based on, for example, a temperature change due to infrared rays radiated from the person.

According to the first comparative example, for example, when the motion of the user is detected by the motion sensor 2, the lighting apparatus 1 can be controlled so that the lighting apparatus 1 is turned on based on the output from the motion sensor 2 (that is, the detection result of the motion of the user). On the other hand, when the motion of the user is not detected by the motion sensor 2, the lighting apparatus 1 can be controlled so as to be turned off.

That is, as described above, the first comparative example using the motion sensor 2 can realize energy saving by providing a service of turning on the lighting apparatus 1 only when a motion of the user is detected.

However, the motion sensor 2 is configured to detect the motion of the user as described above, and cannot detect a user who is not moving.

Therefore, in the first comparative example, when the user does not move (or the user moves little) in the vicinity of the motion sensor 2 after the lighting apparatus 1 is turned on, the lighting apparatus 1 is turned off even though the user is in the vicinity of the lighting apparatus 1, and expected control of the lighting apparatus 1 cannot be realized (that is, lighting control contrary to expectation is performed).

Therefore, in the first comparative example described above, there are cases where it is not possible to realize lighting control that is highly convenient for the user.

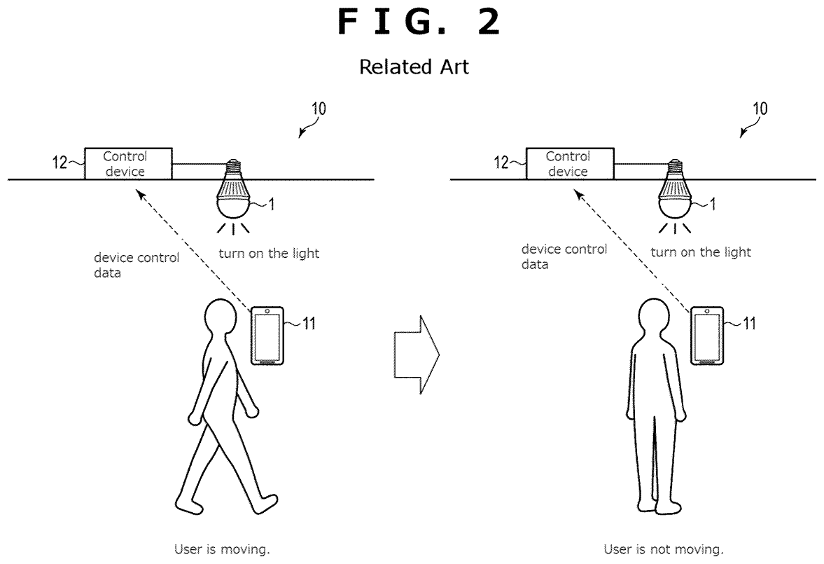

A second comparative example will be described with reference to FIG. 2. In the second comparative example, a service for controlling the lighting apparatus 1 without depending on the motion sensor 2 described above is realized by the communication system 10.

As illustrated in FIG. 2, the communication system 10 includes a terminal device 11 and a control device (or control circuitry) 12. The terminal device 11 is, for example, a smartphone or the like carried by a user, and operates to periodically transmit device control data. The control device 12 corresponds to a communication device having a function of communicating with the terminal device 11. The control device 12 is disposed near the lighting apparatus 1, and operates to turn on the lighting apparatus 1 when the device control data periodically transmitted from the terminal device 11 is received.

According to the communication system 10 according to the second comparative example, for example, regardless of whether or not the user is moving, the lighting of the lighting apparatus 1 can be maintained without turning off the lighting apparatus 1 as long as the control device 12 is in a state where the control device 12 can receive data transmitted from the terminal device 11 carried by the user.

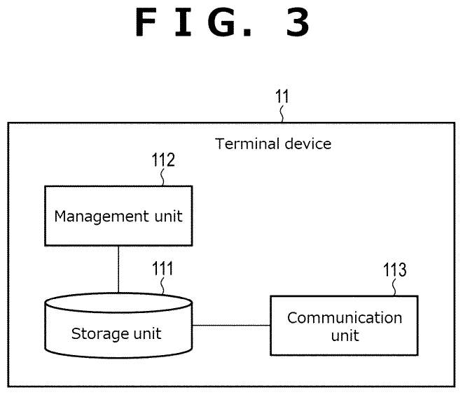

Hereinafter, a communication system 10 according to a second comparative example will be described in detail. FIG. 3 is a block diagram illustrating an example of a functional configuration of the terminal device 11 illustrated in FIG. 2. As illustrated in FIG. 3, the terminal device 11 includes a storage unit 111, a management unit 112, and a communication unit 113. While FIG. 3 and some of the later figures may be used by a comparative example, they may also be used by embodiments/implementations.

The storage unit 111 stores setting information related to device control data transmitted from the terminal device 11 to the control device 12. In the setting information stored in the storage unit 111, for example, a bit pattern or the like is set.

The management unit 112 manages the setting information stored in the storage unit 111. The management unit 112 executes processing such as registration, change, and deletion of the setting information stored in the storage unit 111, for example.

The communication unit 113 refers to the setting information stored in the storage unit 111, for example, and periodically transmits data of a bit pattern set in the setting information (hereinafter, referred to as device control data).

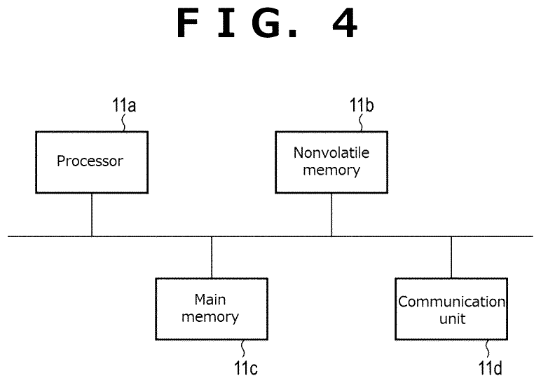

FIG. 4 illustrates an example of a hardware configuration of the terminal device 11. As shown in FIG. 4, the terminal device 11 includes a processor 11a, a nonvolatile memory 11b, a main memory 11c, a communication unit 11d, and the like.

The processor 11a is configured to control operations of components in the terminal device 11, and may be, for example, a CPU. The processor 11a may be a single processor or may be configured by a plurality of processors. The processor 11a executes various programs loaded from the nonvolatile memory 11b to the main memory 11c. The communication unit 11d are devices for realizing communication with the control apparatus 12, for example.

The storage unit 111 illustrated in FIG. 3 is implemented by the nonvolatile memory 11b illustrated in FIG. 4, another storage device, or the like.

In addition, a part or all of the management unit 112 and the communication unit 113 illustrated in FIG. 3 may be realized by causing the processor 11a illustrated in FIG. 4 to execute a predetermined program (that is, software), may be realized by hardware such as an integrated circuit (IC), or may be realized by a configuration in which software and hardware are combined.

Although the terminal device 11 includes the processor 11a, the nonvolatile memory 11b, the main memory 11c, and the communication unit 11d in FIG. 4, the terminal device 11 may further include a touch screen display (a touch panel and a display) or the like if the terminal device 11 is, for example, a smartphone or the like as described above.

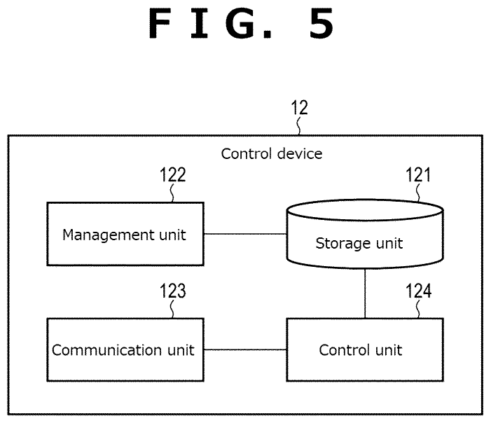

FIG. 5 is a block diagram illustrating an example of a functional configuration of the control device 12 illustrated in FIG. 2. As illustrated in FIG. 5, the control device 12 includes a storage unit 121, a management unit 122, a communication unit 123, and a control unit 124.

The storage unit 121 stores setting information related to device control data transmitted from the terminal device 11 to the control device 12. The setting information stored in the storage unit 121 is the same information as the setting information stored in the storage unit 111 included in the terminal device 11 described above.

The management unit 122 manages the setting information stored in the storage unit 121. The management unit 122 executes processing such as registration, change, and deletion of the setting information stored in the storage unit 121, for example.

The communication unit 123 receives the device control data transmitted from the terminal device 11. Note that the communication unit 123 may receive data other than the device control data, but when the bit pattern of the data received by the communication unit 123 matches the bit pattern set in the setting information stored in the storage unit 121, it can be determined that the data is the device control data (that is, the device control data has been received).

When the device control data is received by the communication unit 123 as described above, the control unit 124 controls the lighting apparatus 1 so that the lighting apparatus 1 is turned on (that is, the lighting apparatus 1 is operated), and sets a time period during which the lighting apparatus 1 is turned on (hereinafter, referred to as a device operation time).

In addition, when the device control data (the device control data of the bit pattern set in the setting information) transmitted from the terminal device 11 is not received during the time from the setting of the device operation time to the elapse of the device operation time as described above, the control unit 124 controls the lighting apparatus 1 such that the lighting apparatus 1 is turned off (that is, the operation of the lighting apparatus 1 is stopped).

Although not shown, the hardware configuration of the control device 12 is substantially the same as that of the terminal device 11 described above, and the control device 12 includes, for example, a processor, a nonvolatile memory, a main memory, a communication device, and the like. In this case, the storage unit 121 illustrated in FIG. 5 is implemented by a nonvolatile memory included in the control device 12, another storage device, or the like. Some or all of the management unit 122, the communication unit 123, and the control unit 124 illustrated in FIG. 5 may be realized by causing a processor included in the control device 12 to execute a predetermined program (that is, software), may be realized by hardware such as an IC, or may be realized by a configuration in which software and hardware are combined.

In the second comparative example, for example, it is assumed that the control device 12 is provided separately from the lighting apparatus 1, but the control device 12 may be incorporated in the lighting apparatus 1 as a control unit, for example.

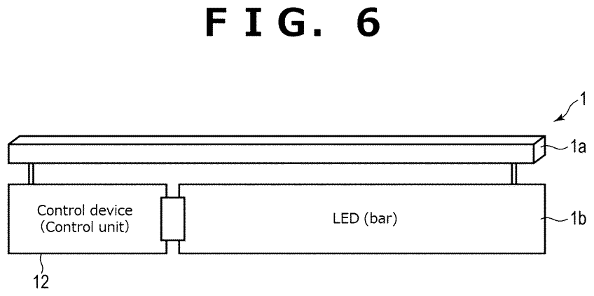

Here, a specific aspect of the lighting apparatus 1 in which the control device 12 is incorporated as a control unit will be described with reference to FIG. 6. In the example shown in FIG. 6, the lighting apparatus 1 includes a lighting apparatus main body 1a and an LED (bar) 1b.

Although not shown in FIG. 6, for example, a host controller (not shown) of the lighting apparatus 1 is incorporated in the lighting apparatus main body 1a, and the host controller is connected to the control device 12. The host controller of the lighting apparatus 1 and the control device 12 may be connected via a connection interface such as a USB connector or a pin slot connector. The connection of the host controller of the lighting apparatus 1 and the control device 12 in this manner corresponds to providing a communication function to the lighting apparatus 1.

The lighting apparatus main body 1a (host interface) may be connected to, for example, a commercial power supply, and may be configured to supply power to the control device 12 connected to the host interface.

Power is supplied to the LED 1b from the lighting apparatus main body 1a. The control device 12 may include actuators for driving the LED 1b, and the actuators are connected to the LED 1b. According to this, the control device 12 can control the turning on and off of the LED 1b. The control device 12 may be configured to adjust the light of the LED 1b via, for example, a dimming I/F.

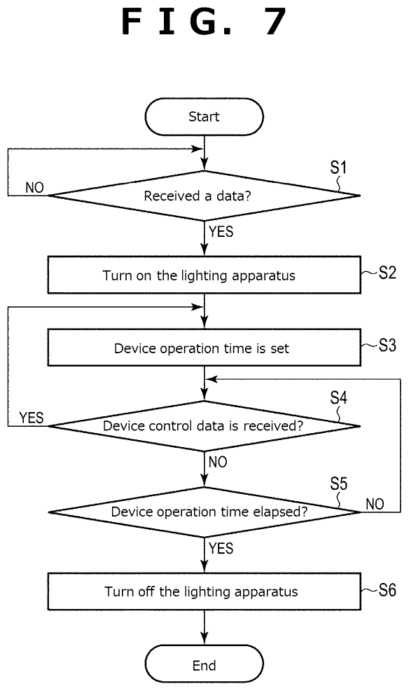

Hereinafter, an example of a processing procedure of the control system 10 according to the second comparative example will be described with reference to the flowchart of FIG. 7. In FIG. 7, the processing of the control device 12 will be mainly described. It is assumed that the lighting apparatus 1 is turned off at the timing when the process of FIG. 7 is started.

First, in the second comparative example, the terminal device 11 and the control device 12 are communicably connected, and it is assumed that, for example, short-range wireless communication is performed between the terminal device 11 and the control device 12. As the short-range wireless communication, wireless communication based on, for example, Bluetooth (registered trademark), Bluetooth Low Energy (hereinafter, referred to as BLE), Wi-Fi (registered trademark), or the like is assumed.

In the second comparative example, the terminal device 11 (the communication unit 113) is configured to periodically transmit device control data corresponding to a beacon, for example, and according to the above-described short-range wireless communication, the control device 12 (the communication unit 123) can receive the data transmitted from the terminal device 11 when the user who carries the terminal device 11 is in the vicinity of the control device 12 (that is, the lighting apparatus 1). On the other hand, when the user who carries terminal device 11 is not in the vicinity of control device 12 (that is, lighting apparatus 1), control device 12 (communication unit 123) cannot receive data transmitted from terminal device 11.

First, control unit 124 included in control device 12 determines whether or not communication unit 123 has received the device control information (information for controlling lighting apparatus 1) transmitted from terminal 11 (step S1).

Here, it is assumed that setting information is stored in the storage unit 111 included in the terminal device 11, and the device control data is data of a bit pattern set in the setting information. In the second comparative example, the bit pattern corresponds to a password set between the terminal device 11 and the control device 12, and as described above, the same setting information as the setting information stored in the storage unit 111 included in the terminal device 11 is stored in the storage unit 121 included in the control device 12.

According to this, the control unit 124 can determine whether or not the data received by the communication unit 123 is the device control data by referring to the setting information stored in the storage unit 121.

That is, for example, even when data is received by the communication unit 123, if the bit pattern of the data received by the communication unit 123 does not match the bit pattern set in the setting information stored in the storage unit 121, it is determined that the device control data is not received by the communication unit 123. When the data is not received by the communication unit 123, it is determined that the device control data is not received by the communication unit 123.

On the other hand, when the bit pattern of the data received by the communication unit 123 matches the bit pattern set in the setting information stored in the storage unit 121, it is determined that the device control data has been received by the communication unit 123.

When it is determined that the device control data is not received by the communication unit 123 (NO in step S1), the process of step S1 is repeated.

On the other hand, when it is determined that the device control data is received by the communication unit 123 (YES in step S1), the control unit 124 controls the lighting apparatus 1 to turn on the lighting apparatus 1 (step S2).

Here, the control unit 124 has a timer, and when the process of step S2 is executed, the above-described device operation time is set in the timer (step S3). When the device operation time has elapsed after the device operation time is set in step S3, the timer operates to notify the elapse of the time. The device operation time set in the timer is assumed to be, for example, 10 minutes, but may be another time. The process of step S3 may be, for example, a process of starting a timer in which a device operation time is set.

Next, the control unit 124 determines whether or not the device control data is received by the communication unit 123 (step S4). The process of step S4 is the same as the process of step S1 described above, and thus the detailed description thereof will be omitted here.

When it is determined that the device control data is received by the communication unit 123 (YES in step S4), the process returns to step S3 and the process is repeated. In other words, when the device control data is received by the communication unit 123 after the device operation time is set in the timer, a process of resetting the device operation time in the timer (that is, updating the timer and extending the device operation time) is executed.

On the other hand, when it is determined that the device control data is not received by the communication unit 123 (NO in step S4), the control unit 124 determines whether or not the device operation time described above has elapsed (step S5). In step S5, when the timer notifies that the device operation time has elapsed (that is, the timer outputs a signal indicating that the device operation time has elapsed because the timer in which the device operation time is set is expired), it can be determined that the device operation time has elapsed.

When it is determined that the device operation time has not elapsed (NO in step S5), the process returns to step S4 and the process is executed.

On the other hand, when it is determined that the device operation time has elapsed (YES in step S5), the control unit 124 controls the lighting apparatus 1 to turn off the lighting apparatus 1 (step S6).

According to the process illustrated in FIG. 7 described above, when the user carrying the terminal device 11 enters the range in which the short-range wireless communication with the control device 12 can be performed, the lighting apparatus 1 can be controlled so that the lighting apparatus 1 is turned on (that is, the lighting of the lighting apparatus 1 is started). According to the process illustrated in FIG. 7, while the user carrying the terminal device 11 is continuously staying within the range in which the short-range wireless communication with the control device 12 can be performed, the device operation time can be extended so that the lighting of the lighting apparatus 1 is continued. Furthermore, according to the process illustrated in FIG. 7, when the user carrying the terminal device 11 has exited the range in which the short-range wireless communication with the control device 12 can be performed, the lighting apparatus 1 can be controlled so that the lighting apparatus 1 is turned off (that is, the lighting of the lighting apparatus 1 is stopped).

Note that, in FIG. 7, the terminal device 11 and the control device 12 are described as performing wireless communication (short-range wireless communication) based on, for example, Bluetooth or the like, but wireless communication based on, for example, Wi-Fi (registered trademark), LoRa (registered trademark), or the like may be performed between the terminal device 11 and the control device 12, or wireless communication based on other standards may be performed. However, in the second comparative example of the present embodiment, since it is necessary to turn on the lighting apparatus 1 when the user who carries the terminal device 11 is in the vicinity of the control device 12, in a case where wireless communication based on, for example, Wi-Fi or the like is performed between the terminal device 11 and the control device 12, the distance between the terminal device 11 and the control device 12 may be estimated based on the signal reception strength of device control data received by the control device 12, and the lighting apparatus 1 is turned on when the estimated distance is equal to or less than a predetermined value. Instead of estimating the distance, the signal strength of the device control data of the terminal device 11 received by the control device 12 may be used, and the lighting apparatus 1 may be turned on when the signal strength is equal to or greater than a predetermined value.

In FIG. 7, since the lighting apparatus 1 can be turned on by the control device 12 receiving data of a bit pattern set in the setting information (that is, device control data), the lighting apparatus 1 cannot be turned on in the communication system 10 unless the terminal device 11 has the setting information registered therein (that is, the terminal device 11 has the setting information stored in the storage unit 111), for example. In other words, in the communication system 10 according to the second comparative example, it is possible to provide a service of controlling the lighting apparatus 1 only to a specific user who carries the terminal device 11 whose setting information is registered in advance, and to avoid a situation in which the lighting apparatus 1 is turned on by a beacon or the like transmitted from another terminal device.

In the second comparative, the bit pattern set in the setting information registered in the terminal device 11 may be different for each user who can use the communication system 10, or may be common to a plurality of users who can use the communication system 10, for example.

Here, as described above, in the second comparative example, it is necessary to register the setting information in the terminal device 11 in advance, but the setting information can be registered (stored) in the terminal device 11 by, for example, downloading an application program (hereinafter, referred to as a device control application) for operating as the terminal device 11 in the communication system 10 to the terminal device 11. According to this, by activating an application program in the terminal device 11 and setting a service (function) for controlling the lighting apparatus 1 to be enabled, it is possible to periodically transmit device control data of a bit pattern set in the setting information from the terminal device 11.

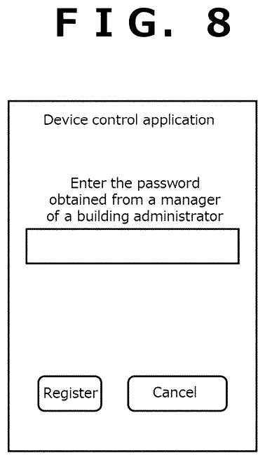

The setting information may be registered in the terminal device 11 by inputting a password obtained from a manager of a building in which the lighting apparatus 1 is installed on a screen as illustrated in FIG. 8 displayed on the terminal device 11 when the device control application is activated (that is, based on an input operation of the user performed on the terminal device 11).

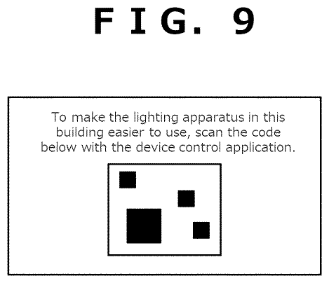

Further, the setting information may be registered by reading a two-dimensional code as illustrated in FIG. 9, which is arranged in a building, by the terminal device 11 that has started the device control application. In this case, the setting information encoded in the two-dimensional code may be registered in the terminal device 11, or the setting information acquired through user authentication or the like after accessing a uniform resource locator (URL) encoded in the two-dimensional code may be registered in the terminal device 11.

Here, the description has been made assuming that the setting information is newly registered in the terminal device 11, but the process of registering the setting information described above may be executed when the setting information (or the bit pattern included in, or the like) is changed or switched.

Here, in the second comparative example, it has been described that the lighting apparatus 1 is controlled (for example, turned on) when the device control data matching the bit pattern set in the setting information stored in the storage unit 121 included in the control device 12 (hereinafter, referred to as setting information of the control device 12) is received, but the content of the control to be performed may be different according to the bit pattern.

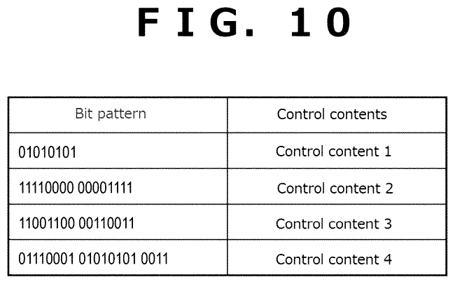

FIG. 10 illustrates an example of the setting information of the control device 12. As illustrated in FIG. 10, the setting information of the control device 12 includes control contents (permission control) in association with each of a plurality of bit patterns. In other words, the setting information is information in which different control contents are set for the respective bit patterns.

In the example illustrated in FIG. 10, for example, in a case where the device control data having a bit pattern of “01010101” is transmitted from the terminal device 11, it is indicated that control of “control content 1” is performed.

In addition, in the example illustrated in FIG. 10, for example, in a case where the device control data having a bit pattern of “11110000 00001111” is transmitted from the terminal device 11, it is indicated that control of “control content 2” is performed.

Furthermore, in the example illustrated in FIG. 10, for example, in a case where the device control data having a bit pattern of “11001100 00110011” is transmitted from the terminal device 11, it is indicated that control of “control content 3” is performed.

In addition, in the example illustrated in FIG. 10, for example, in a case where the device control data having a bit pattern of “01110001 01010101 0011 ” is transmitted from the terminal device 11, it is indicated that control of “control content 4” is performed.

That is, according to the setting information of the control device 12 as illustrated in FIG. 10, it is possible to perform control of different contents based on data transmitted from the terminal device 11 according to the setting information (that is, bit pattern) registered in the terminal device 11.

Although the setting information illustrated in FIG. 10 has been described as including the bit pattern and the control content in association with each other, the setting information may include, for example, unique data for identifying the terminal device 11, the device control application operating on the terminal device 11, or the user who carries the terminal device 11, instead of the bit pattern. According to such setting information, for example, the unique data is transmitted from the terminal device 11, and thus it is possible to perform control according to the unique data.

The setting information may include the bit pattern, and the unique data described above. In this case, for example, the device control data in which the bit pattern and the unique data are stored (arranged) at different start positions is transmitted from the terminal device 11, and thus it is possible to perform control according to a combination of the bit pattern and the unique data.

In addition, although different control contents are set for each bit pattern in the setting information illustrated in FIG. 10, the control contents may be different in, for example, a time for which the lighting apparatus 1 is turned on (that is, a device operation time) for each bit pattern. The device operation time may be set to, for example, 10 seconds, 60 seconds, 10 minutes, 60 minutes, or the like. In addition, in the control content, for example, the brightness of the lighting apparatus 1 when the lighting apparatus 1 is turned on may be different for each bit pattern.

The setting information in the second comparative example can be said to be information indicating a condition for controlling the lighting apparatus 1, for example, and it is possible to realize controls of the various lighting apparatus 1 by receiving device control data matching the condition.

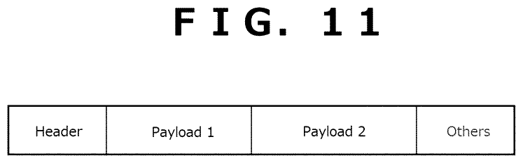

An example of the data structure (packet format) of the device control data transmitted from the terminal device 11 will be described below with reference to FIG. 11. Here, it is assumed that the device control data is transmitted as a beacon of BLE, for example.

As illustrated in FIG. 11, the device control data transmitted from the terminal device 11 includes a header, a payload 1, and a payload 2.

The header stores management information defined by a communication scheme used when the terminal device 11 transmits the device control data. The management information includes, for example, a packet type, address information, and the like.

The payload 1 stores data of the above-described bit pattern. The payload 2 stores the above-described unique data. The unique data corresponds to, for example, data unique to the terminal device 11, data unique to the device control application, or data unique to the user.

Data defined by a communication scheme used when the device control data is transmitted from the terminal device 11, additional data, or the like may be added to the data transmitted from the terminal device 11 as other data.

The data structure illustrated in FIG. 11 is an example, and one of the payload 1 and the payload 2 may be omitted in the device control data transmitted from the terminal device 11. In addition, in the device control data transmitted from the terminal device 11, the order of the payload 1 and the payload 2 may be opposite to the data structure illustrated in FIG. 11.

Note that, although the second comparative example has been described assuming that a service for controlling the lighting apparatus 1 is provided only to a specific user by the setting information being registered in the terminal device 11 and the control device 12, a simple configuration in which the setting information is omitted may be adopted as long as the lighting apparatus 1 is controlled when arbitrary data transmitted from the terminal device 11 is simply received by the control device 12, for example.

As described above, the control system 10 according to the second comparative example includes the terminal device 11 configured to periodically transmit the device control data, and the control device 12 configured to receive the data transmitted from the terminal device 11. In the second comparative example, when the device control data is received, the control device 12 controls the lighting apparatus 1 so that the lighting apparatus 1 is turned on, and sets a device operation time (a time during which the lighting apparatus 1 is turned on). In addition, when the device control data is not received during a time from the setting of the device operation time to the elapse of the device operation time, the control device 12 controls the lighting apparatus 1 so that the lighting apparatus 1 is turned off.

In the second comparative example, the above-described configuration makes it possible to improve the convenience of the user.

Specifically, in the first comparative example described with reference to FIG. 1 described above, the lighting apparatus 1 is turned off when the user is not moving in the vicinity of the motion sensor 2, whereas according to the communication system 10 according to the second comparative example, as described with reference to FIG. 2, the lighting apparatus 1 can be turned on even when the user is not moving, and thus it is possible to realize control of the lighting apparatus 1 expected by the user.

In addition, in the second comparative example, when there is no user in the vicinity of the lighting apparatus 1, the lighting apparatus 1 can be turned off, and thus energy saving related to the control of the lighting apparatus 1 can be realized.

In the second comparative example, the communication performed between the terminal device 11 and the control device 12 is assumed to be short-range wireless communication based on, for example, Bluetooth or the like. According to such a configuration, since it is not necessary to perform work such as a local area network (LAN) connection or a wide area network (WAN) connection to the lighting apparatus 1 in order to realize the control of the lighting apparatus 1 (that is, to provide a service for controlling the lighting apparatus 1), it is possible to easily realize the control system 10. Furthermore, the second comparative example is advantageous in that the control of the lighting apparatus 1 based on the device control data transmitted from the terminal device 11 can be performed offline without preparing a server device or the like (that is, without introducing a large-scale communication network).

In addition, in the second comparative example, by the configuration in which the device operation time is set again when the device control data is received before the device operation time elapses, it is possible to continue the lighting of the lighting apparatus 1 stably as long as the user is present in the vicinity of the lighting apparatus 1 (that is, the device control data is received by the control device 12).

In addition, in the second comparative example, with the configuration in which data of a bit pattern set in advance (that is, device control data) is transmitted and received between the terminal device 11 and the control device 12, for example, it is possible to provide a service of controlling the lighting apparatus 1 to a specific user who carries the terminal device 11 in which setting information in which a bit pattern is set is registered.

Furthermore, in the second comparative, for example, by referring to setting information including different control contents in association with each of a plurality of bit patterns, the lighting apparatus 1 may be controlled based on the control contents included in the setting information in association with the bit pattern of the received device control data. According to such a configuration, it is possible to perform appropriate control of the lighting apparatus 1 according to (the bit pattern of) the device control data transmitted from the terminal device 11.

In the second comparative example, the case where the device to be controlled (hereinafter referred to as a control target device) is the lighting apparatus 1 has been mainly described, but the control target device may be a device other than the lighting apparatus 1.

Specifically, the control target device may be a display device (display). In a case where the control target device is a display device, for example, while the device control data transmitted from the terminal device 11 carried by the user is received by the control device 12 due to the user approaching, it is possible to display predetermined information on the display device. The display device in this case may be, for example, a display installed in a vending machine or the like, a display installed for the purpose of displaying an advertisement, or the like.

The control target device may be a sensing device (sensor). In a case where the control target device is a sensing device, for example, while the device control data transmitted from the terminal device 11 carried by the user is received by the control device 12 due to the user approaching, the sensing device can perform sensing (collection, measurement, detection, or the like of data). Note that the data obtained by sensing may be transmitted to the terminal device 11, for example. Such a communication system 10 can be used, for example, in a plant equipment patrol.

Further, the control target device may be an actuator. In a case where the control target device is an actuator, for example, the actuator can operate while the device control data transmitted from the terminal device 11 carried by the user is received by the control device 12 due to the user approaching the control target device. The actuator in this case may operate to open and close a door set in a building, for example. The actuator may also operate to drive a player or speaker that plays music or sounds that are broadcast as advertisements, for example in a supermarket or the like.

Here, for example, it is assumed that the control target device in the second comparative example is the lighting apparatus 1, and the lighting apparatus 1 and the control device 12 that controls the lighting apparatus 1 are installed in a toilet in a building. In such a case, it is possible to control the lighting apparatus 1 such that the lighting apparatus 1 is turned on when the user carrying the terminal device 11 enters the toilet and the lighting apparatus 1 is turned off after the user leaves the toilet.

However, the terminal device 11 in such a case may not be carried by the user. Specifically, the terminal device 11 is realized as a tag or the like configured to transmit a beacon, and may be attached to a door of a private room of a toilet, for example. In this case, the terminal device 11 is connected to a sensor capable of detecting opening and closing of a door of a private room of a toilet or a key of the door, for example, and can operate to periodically transmit the device control data when the door or the key of the door is closed.

The terminal device 11 may be attached to a toilet seat, for example. In this case, the terminal device 11 is connected to a sensor capable of detecting opening and closing of a lid of a toilet seat, for example, and can operate to periodically transmit the device control data when the lid of the toilet seat is open. The terminal device 11 may be connected to a sensor capable of detecting whether or not the user is sitting on the toilet seat according to the distortion of the toilet seat, and may operate to periodically transmit the device control data when the user is sitting on the toilet seat.

According to such a configuration, even when the user does not carry the terminal device 11, the lighting apparatus 1 can be turned on when the user is in the toilet, and the lighting apparatus 1 is not turned off even when the user in the toilet moves less.

Note that, as described above, when the communication system 10 according to the second comparative example is applied to a toilet, the control target device may be a device configured to play sound during use of the toilet, instead of the lighting apparatus 1.

In the second comparative example, the setting information is registered in the terminal device 11 by downloading the device control application to the terminal device 11, for example. However, the setting information may be registered by another method. Specifically, the setting information may be registered based on an input operation of the user performed on the terminal device 11 after the device control application is activated as described above, or may be registered by reading the two-dimensional code with the terminal device 11.

Further, as described above, when the setting information including different control contents is stored in the storage unit 121 included in the control device 12 in association with each of the plurality of bit patterns, for example, a bit pattern selected from the plurality of bit patterns by a dip switch or the like attached to the terminal device 11 may be registered in the terminal device 11 as the setting information. For example, when a dip switch is attached to the control target device, a bit pattern effective for controlling the control target device may be selected from the plurality of bit patterns by the dip switch.

Note that, in the second comparative example, the communication system 10 for providing a service of controlling a control target device without depending on the motion sensor 2 illustrated in FIG. 1 has been described, but the control target device may be controlled by using both the motion sensor 2 and the control device 12.

Specifically, in the second comparative example, the control target device is controlled so that the control target device operates based on the device control data periodically transmitted from the terminal device 11, but the control target device may not appropriately operate at the timing when the user approaches the control target device depending on the interval at which the device control data is transmitted.

In consideration of this point, for example, in a case where the motion of the user is detected by the motion sensor 2 before the device control data transmitted from the terminal device 11 is received by the control device 12, the control target device may be operated based on the output from the motion sensor 2 (the detection result of the motion sensor 2). However, in order to avoid the operation of the control target device being stopped even though the user is in the vicinity as described above, the operation of the control target device is continued while the device control data transmitted from the terminal device 11 is received by the control device 12 even when the motion sensor 2 does not detect the motion of the user.

That is, in the configuration in which the motion sensor 2 and the control device 12 are used in combination according to the second comparative example as described above, priority is given to control based on the output of the motion sensor 2 when the control target device is operated, and priority is given to control based on the data transmitted from the terminal device 11 when the operation of the control target device is stopped.

For example, in a case where the terminal device 11 is a smartphone or the like, when the user leaves the terminal device 11 in the vicinity of the control target device, a situation in which the control target device continues to operate even though the user is not in the vicinity of the control target device may occur. Therefore, for example, in a case where a time in which the control device 12 continues to receive the device control data transmitted from the terminal device 11 exceeds a predetermined time, the control based on the output of the motion sensor 2 may be prioritized over the control based on the device control data transmitted from the terminal device 11, and the operation of the control target device may be stopped.

The time in which the control based on the output of the motion sensor 2 is prioritized and the time in which the control based on the device control data transmitted from the terminal device 11 is prioritized (that is, the priority for each control) may be set in the setting information of the control device 12, for example.

In the second comparative example described above, when the user who carries the terminal device 11 is in the vicinity of the control device 12, for example, the lighting apparatus 1 can be controlled so that the lighting apparatus 1 operates, but in a building such as a medium-scale facility or a large-scale facility in which a large number of lighting apparatuses 1 are installed, it is conceivable to construct a remote control system (central control system) that remotely controls the lighting apparatus 1. According to such a remote control system, for example, by individually remotely controlling the lighting apparatuses 1 installed at specific positions (for example, on a floor) according to the surrounding environment, situation, and the like, it is possible to realize higher energy saving.

However, in order to realize remote control of a large number of lighting apparatuses 1 in a remote control system, it is necessary to register the positions where the lighting apparatuses 1 are installed in the remote control system in advance. The position where such a lighting apparatus 1 is installed can be registered by, for example, manually checking the correspondence relationship between the lighting ID of the lighting apparatus 1 installed in the building and the installation position of the lighting apparatus 1, but in a case where a large number of lighting apparatuses 1 are installed in the building as described above, the work requires a lot of labor and time.

In view of this, the present embodiment provides a mechanism for supporting the registration operation of the position where the lighting apparatus 1 is installed, by using the communication system 10 (the terminal device 11 and the control device 12) described in the second comparative example.

Hereinafter, the communication system 10 according to the present embodiment will be described, but detailed description of the same parts as those of the second comparative example described above will be omitted, and parts different from those of the second comparative example will be mainly described.

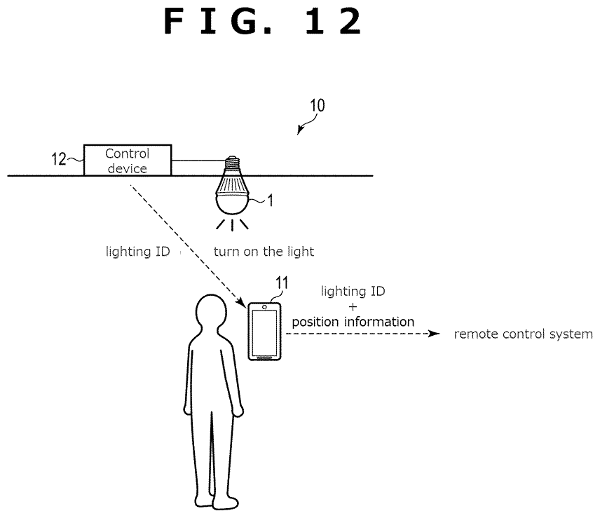

First, an overview of a communication system 10 according to the present embodiment will be described with reference to FIG. 12. As illustrated in FIG. 12, the control device 12 transmits the lighting ID of the lighting apparatus 1 (device identification information for identifying the lighting apparatus 1) controlled by the control device 12 at predetermined intervals or at predetermined timing (for example, periodically). When the terminal device 11 receives the lighting ID transmitted from the control device 12, the terminal device 11 acquires the position information of the terminal device 11 (position information indicating the position of the terminal device 11).

The terminal device 11 transmits the received lighting ID and the acquired position information. The correspondence relationship between the lighting ID and the position information transmitted from the terminal device 11 in this manner is registered in a remote control system (a server device having a function of remotely controlling the lighting apparatus 1) and is used to remotely control the lighting apparatus 1. In the present embodiment, registering the correspondence relationship between the lighting ID and the position information corresponds to registering the position information in association with the lighting ID, and the remote control system can recognize that the lighting apparatus 1 identified by the lighting ID is installed at the position indicated by the position information associated with the lighting ID by referring to the correspondence relationship.

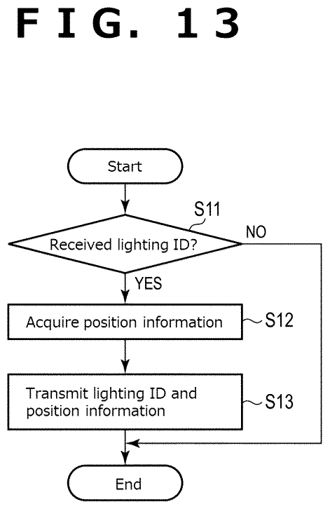

Next, an example of a processing procedure of the communication system 10 according to the present embodiment will be described with reference to a flowchart of FIG. 13. In FIG. 13, the processing of the terminal device 11 will be mainly described.

Since the functional configurations of the terminal device 11 and the control device 12 in the present embodiment are the same as those in the second comparative example described above, the functional configurations of the terminal device 11 and the control device 12 will be described with reference to FIGS. 3 and 5 as appropriate.

In the present embodiment, it is assumed that the lighting IDs of the lighting apparatuses 1 controlled by the control device 12 are stored in advance in the storage unit 121 included in the control device 12. In this case, the communication unit 123 transmits the lighting ID stored in the storage unit 121 at predetermined intervals. In other words, in the present embodiment, the lighting ID is advertised by the control device 12 (lighting apparatus 1) at predetermined intervals through wireless communication.

Here, in the present embodiment, as described in the second comparative example, the short-range wireless communication is performed between the terminal device 11 and the control device 12, and the terminal device 11 (the communication unit 113) can receive the lighting ID transmitted from the control device 12 when the user who carries the terminal device 11 is in the vicinity of the control device 12.

Therefore, for example, the management unit 112 included in the terminal device 11 determines whether or not the lighting ID transmitted from the control device 12 has been received (step S11).

Here, as described above, when the control device 12 that performs the short-range wireless communication with the terminal device 11 is disposed in the vicinity of the lighting apparatus 1, it can be said that the position of the terminal device 11 that can receive the lighting ID transmitted from the control device 12 is at least a position in the vicinity of the lighting apparatus 1. Therefore, in the present embodiment, the position of the terminal device 11 in this case is used as the installation position of the lighting apparatus 1.

To be more specific, when it is determined that the lighting ID is received (YES in step S11), the management unit 112 acquires the position information of the terminal device 11 at the time when the lighting ID is received (step S12).

Note that, in the step S12, the position information of the terminal device 11 is acquired by a position specifying function of the terminal device 11 (for example, a smartphone). The position specifying function may be, for example, a function of acquiring position information using a global positioning system (GPS) mounted on the terminal device 11, or may be a function of acquiring position information using the position of a base station or an access point that communicates with the terminal device 11.

The position information acquired in the step S12 is stored in the storage unit 111 together with the received lighting ID, for example.

The communication unit 113 transmits the lighting ID and the position information stored in the storage unit 111 to the remote control system (step S13).

The correspondence relationship between the lighting ID and the position information transmitted in the step S13 is registered in the remote control system. Accordingly, the remote control system can individually control the lighting apparatuses 1 after grasping that the lighting apparatuses 1 identified by the lighting IDs are installed at the positions indicated by the position information using the correspondence relationship between the lighting IDs and the position information.

On the other hand, when it is determined that the lighting ID is not received (NO in step S11), the process illustrated in FIG. 13 is ended.

According to the process illustrated in FIG. 13, for example, each time the user carrying the terminal device 11 moves to the vicinity of the lighting apparatus 1 (control device 12), the lighting ID and the installation position of the lighting apparatus 1 (the position of the terminal device 11 that can be regarded as the lighting ID and the installation position) can be automatically registered in the remote control system.

Note that, although the processing of steps S11 to S13 is described as being executed in order in FIG. 13, for example, the processing of steps S11 and S12 may be repeated, and (pairs of) the lighting IDs and the position information stored (accumulated) in the storage unit 111 may be transmitted to the remote control system in the processing of step S13 executed at a predetermined timing.

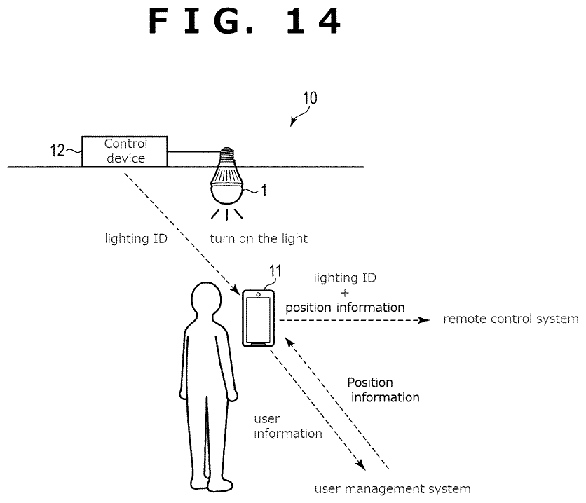

In addition, although it has been described that the position information is acquired by the position specifying function of the terminal device 11 at the step S12, the position information of the terminal device 11 can be regarded as the position information of the user who carries the terminal device 11 (that is, the position information indicating the position of the user), and thus, for example, the position information may be acquired from a user management system that manages the position of the user. The user management system is assumed to be a system that grasps and manages the position of a user by receiving a beacon transmitted from a dedicated tag or the like carried by the user by at least one of a large number of receivers arranged in a building, for example. In this case, for example, as illustrated in FIG. 14, the terminal device 11 transmits user information for specifying a user who carries the terminal device 11 from the terminal device 11 to the user management system, and thus, the terminal device 11 can acquire position information indicating a position of the user specified by the user information (that is, a position of the user managed in the user management system) from the user management system. The user information corresponds to a user identifier, and includes a user name, a mail address of the user, a user ID, or the like. In addition, the terminal device 11 can acquire the position information of the user at the date and time indicated by the time stamp by transmitting the user information to which the time stamp is attached.

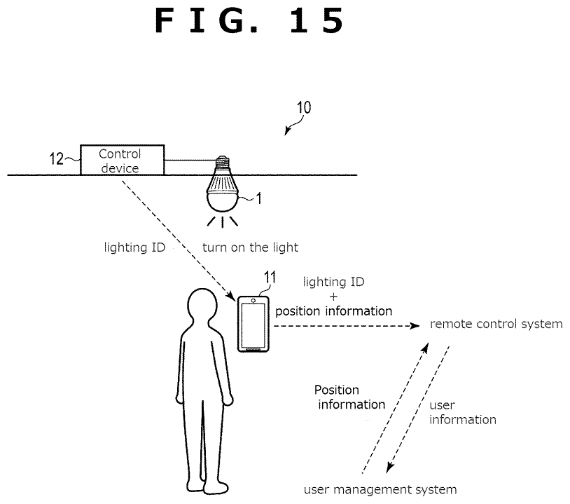

In the present embodiment, if the correspondence relationship between the lighting ID and the position information is registered in the remote control system, the remote control system may acquire the position information from the user management system as illustrated in FIG. 15. In this case, the terminal device 11 may operate to transmit the lighting ID and the user information to the remote control system. The remote control system may transmit the user information transmitted from the terminal device 11 to the user management system and acquire the position information indicating the position of the user specified by the user information from the user management system.

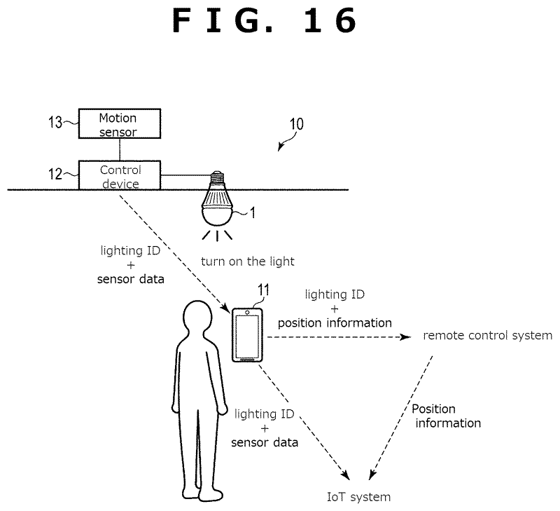

Further, although the lighting ID is transmitted from the control device 12 at predetermined intervals in FIG. 13, for example, as illustrated in FIG. 16, when a sensor 13 used by an Internet of Things (IoT) system is connected to the control device 12, the lighting ID and data (sensor data) measured by the sensor 13 may be transmitted from the control device 12 at predetermined intervals. Note that, although the sensor 13 is assumed to be directly attached to the control device 12, the sensor 13 may be located at least in the vicinity of the control device 12.

In this case, the terminal device 11 operates to transmit the lighting ID and the sensor data to the IoT system. The lighting ID transmitted to the IoT system in this manner can be used as position information in the IoT system. Specifically, the IoT system inquires of the remote control system about the installation position of the lighting apparatus 1 identified by the lighting ID transmitted from the terminal device 11 (that is, the installation position corresponding to the lighting ID), for example. Accordingly, the IoT system can provide an IoT service using the sensor data assuming that the sensor data is measured at the installation position acquired from the remote control system as a response to the inquiry.

The terminal device 11 may transmit the lighting ID and the sensor data to the IoT system together with a time stamp, and the IoT system can grasp the date and time when the sensor data is measured according to such a time stamp. The IoT system may be a remote control system, and the remote control system may remotely control the lighting apparatus 1 using sensor data transmitted from the terminal device 11.

As described above, in the communication system 10 according to the present embodiment, each of the plurality of control devices 12 (or control circuitries 12) transmits the lighting ID (device identification information for identifying the control target device) of the lighting apparatus 1 controlled by the control device 12 at predetermined intervals, and when the lighting ID transmitted from one control device 12 among the plurality of control devices 12 is received, the terminal device 11 acquires the position information of the terminal device 11 and transmits the received lighting ID and the acquired position information.

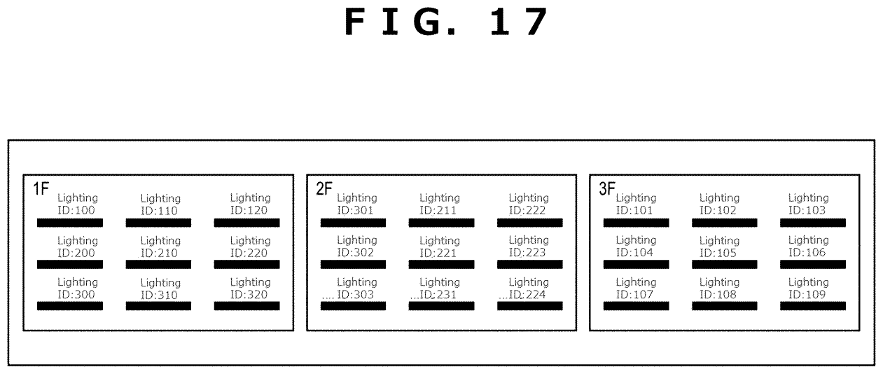

Here, FIG. 17 illustrates an example of arrangement of the plurality of lighting apparatuses 1 installed on the first to third floors of a building, for example. In the example illustrated in FIG. 17, it is assumed that nine lighting apparatuses 1 having lighting IDs “100”, “110”, “120”, “200”, “210”, “220”, “300”, “310”, and “320” are installed on the first floor of the building. In addition, it is assumed that nine lighting apparatuses 1 having lighting IDs “301”, “211”, “222”, “302”, “221”, “223”, “303”, “231”, and “224” are installed on the second floor of the building. Further, it is assumed that nine lighting apparatuses 1 having lighting IDs “101”, “102”, “103”, “104”, “105”, “106”, “107”, “108”, and “109” are installed on the third floor of the building.

In the example illustrated in FIG. 17, it is assumed that the lighting apparatuses 1 installed on the first floor are remotely controlled in the remote control system in accordance with a change in the environment on the first floor, for example. In this case, the remote control system can control the lighting apparatuses 1 identified by the lighting IDs by designating the lighting IDs illustrated in FIG. 17, but for example, if the fact that the lighting apparatus 1 having the lighting ID “100” is installed on the first floor (that is, the correspondence relationship between the lighting ID “100” and the position information “first floor”) is not registered in the remote control system, the lighting ID to be designated to control the lighting apparatus 1 installed on the first floor is unknown, and the lighting apparatus 1 installed on the first floor cannot be remotely controlled in the remote control system. Although the lighting apparatus 1 identified by the lighting ID “100” has been described here, the same applies to the other lighting apparatuses 1.

In the present embodiment, a user who carries the terminal device 11 moves in the vicinity of each of the plurality of lighting apparatuses 1 installed in the building (the first floor to the third floor), and thus the lighting ID of the lighting apparatus 1 and the position information of the terminal device 11 (that is, the installation position of the lighting apparatus 1) transmitted from the terminal device 11 can be registered in the remote control system.

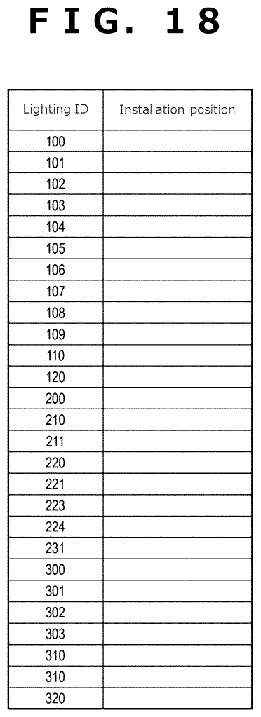

Hereinafter, the installation positions of the lighting apparatuses 1 registered in the remote control system will be described in detail with reference to FIGS. 18 to 20.

FIG. 18 illustrates a state in which the installation position of the lighting apparatus 1 corresponding to each lighting ID (that is, the position information indicating the position of the lighting apparatus 1 identified by the lighting ID) is not registered in the remote control system. In other words, FIG. 18 illustrates a registered state of the installation positions of the lighting apparatuses 1 before the process of FIG. 13 is executed.

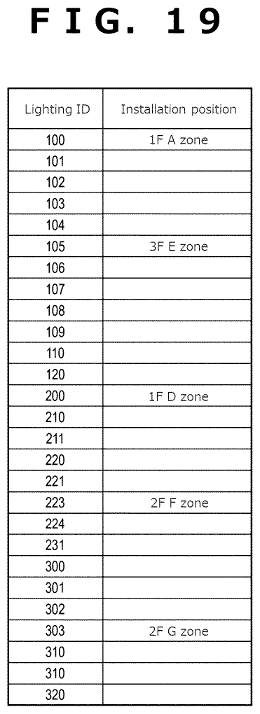

Here, for example, when the user moves to the vicinity of the lighting apparatus 1 having the lighting ID “100” (that is, the lighting apparatus 1 identified by the lighting ID “100”), the lighting ID “100” and the position information of the terminal device 11 are transmitted from the terminal device 11 carried by the user to the remote control system. In this case, as illustrated in FIG. 19, “1F A zone” indicating a region including the position indicated by the position information of the terminal device 11 is registered in the remote control system as the installation position of the lighting apparatus 1 identified by the lighting ID “100”. It is assumed that the installation position of the lighting apparatus 1 is represented by one zone (that is, a predetermined range including the position indicated by the position information) among zones A to I into which each floor (first to third floors) is divided, but may be represented by coordinate values or the like defined in advance. Alternatively, the position information of the terminal device 11 (the position indicated by the position information) may be registered as the installation position of the lighting apparatus 1.

Although the installation position of the lighting apparatus 1 identified by the lighting ID “100” (that is, the installation position of the lighting apparatus 1 registered in association with the lighting ID “100”) has been described here, in the example illustrated in FIG. 19, the installation positions of the lighting apparatuses 1 are further registered in association with the lighting IDs “105”, “200”, “223”, and “303” according to the place in the building to which the user carrying the terminal device 11 has moved.

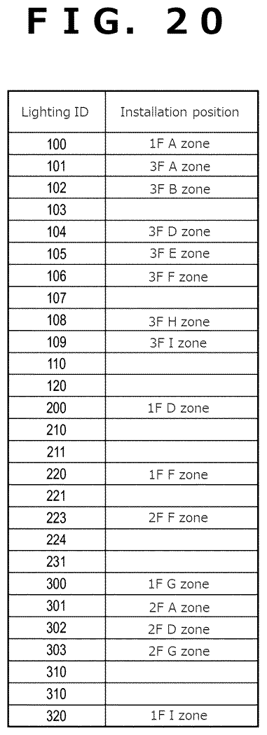

Although a detailed description is omitted, when the user carrying the terminal device 11 further moves in the building, the installation positions of more lighting apparatuses 1 can be registered in the remote control system as illustrated in FIG. 20. That is, in the present embodiment, since the installation positions corresponding to the lighting IDs are automatically registered, the communication system 10 according to the present embodiment is useful for realizing control of the plurality of lighting apparatuses 1 using the installation positions.

Note that, as described above, if the user who carries the terminal device 11 can use the service for controlling the lighting apparatus 1 described in the second comparative example, in the present embodiment, the installation position of the lighting apparatus 1 described above can be automatically registered in the remote control system only by the user using the service. In other words, in the present embodiment, it is not necessary to perform a special operation for registering the installation position of the lighting apparatus 1, and it is possible to realize that the lighting ID and the installation position are associated with each other during the operation of the service for controlling the lighting apparatus 1.

In addition, although the case where the user who uses the service for controlling the lighting apparatuses 1 carries the terminal device 11 has been described here, in the present embodiment, for example, a worker who registers the installation positions of the lighting apparatuses 1 in the remote control system may move near the lighting apparatuses 1 while carrying the terminal device 11. Even in such a case, the worker only needs to move in the building while carrying the terminal device 11 such as a smartphone, and it is possible to significantly reduce labor and time compared to, for example, work of manually checking the correspondence relationship between the lighting ID and the installation position for each lighting apparatus 1. Further, instead of the worker who carries the terminal device 11, a mobile robot having the function of the terminal device 11 may move in the building.

Here, in the present embodiment, the position information of the terminal device 11 when the lighting ID transmitted from the control device 12 is received is registered in the remote control system as the installation position of the lighting apparatus 1, but according to the short-range wireless communication such as Bluetooth, the terminal device 11 can receive the lighting ID up to a range of about ten and several meters from the control device 12, and thus, it is considered that the position indicated by the position information has an error with the actual installation position of the lighting apparatus 1.

On the other hand, when the terminal device 11 receives the lighting ID transmitted from the control device 12, the signal reception strength of the lighting ID becomes a higher value as the terminal device 11 is located closer to the control device 12 (that is, the lighting apparatus 1).

Therefore, the terminal device 11 may further transmit the signal reception strength at the time of receiving the lighting ID to the remote control system together with the lighting ID of the lighting apparatus 1 and the position information of the terminal device 11. Assuming that there are a plurality of users who use the service for controlling the lighting apparatus 1 in a building, for example, when different users move in the vicinity of the lighting apparatus 1, a plurality of installation positions corresponding to the same lighting ID may be registered in the remote control system. In this case, by using the installation position when the lighting ID having the high reception intensity is received among the plurality of installation positions, it is possible to improve the accuracy of the remote control for the lighting apparatus 1.

Note that, although the reception intensity of the lighting ID is transmitted together with the lighting ID and the position information in the above description, if a reception angle of a signal (AoA: Angle of Arrival) of the lighting ID can be acquired when the lighting ID is received, the reception angle may be used instead of the reception intensity. The closer the lighting apparatus is, the larger (or smaller) the reception angle of the lighting ID is.

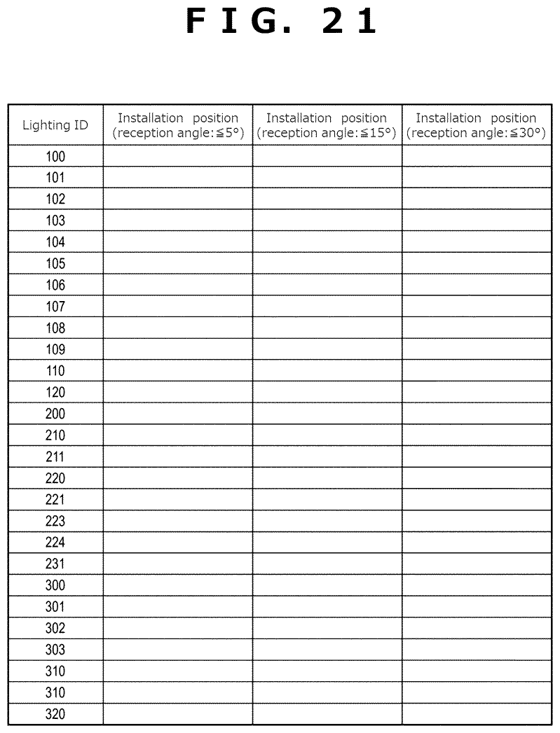

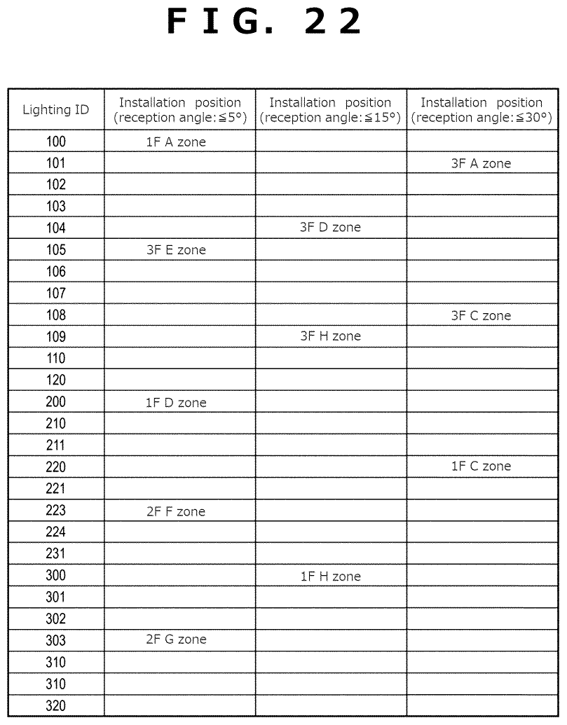

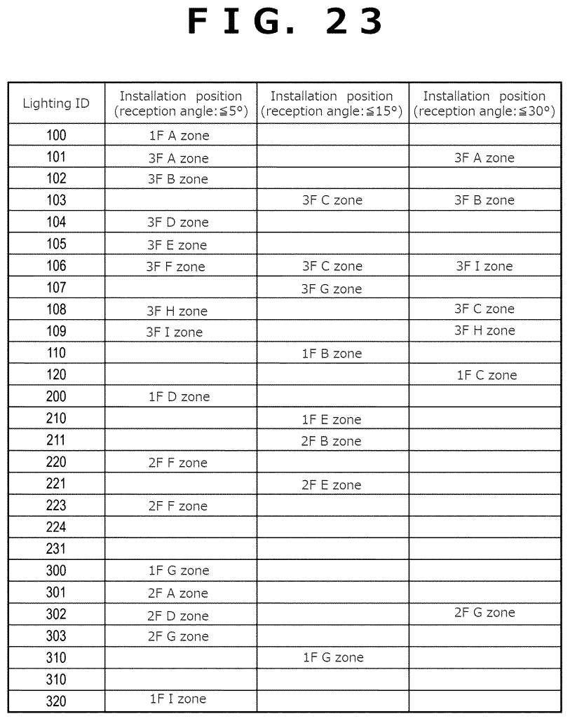

FIGS. 21 to 23 illustrate examples of installation positions of the lighting apparatuses 1 registered in the remote control system when the lighting IDs and the position information are transmitted from the terminal device 11 to the remote control system and the reception angles are acquired. Note that FIG. 21 corresponds to FIG. 18 described above, FIG. 22 corresponds to FIG. 19, and FIG. 23 corresponds to FIG. 20, except that the reception angle is taken into consideration. In this example, it is assumed that the reception angle is 0 degrees when the lighting apparatus is located directly above the terminal device, and the angle increases as the terminal device moves away from the lighting apparatus, but the present invention is not limited thereto.

According to the examples illustrated in FIGS. 21 to 23, the installation position of the lighting apparatus 1 is registered in the remote control system in association with the lighting ID and the reception angle of the lighting apparatus 1.

For example, in the example illustrated in FIG. 23, for the lighting ID “106”, for example, “3F F zone” is registered as an installation position where the reception angle is 5 degrees or less, “3F C zone” is registered as an installation position where the reception angle is 15 degrees or less (and larger than 5 degrees), and “3F I zone” is registered as an installation position where the reception angle is 30 degrees or less (and larger than 15 degrees).

In this case, the remote control system controls the lighting apparatus 1 identified by the lighting ID “106” on the assumption that the lighting apparatus 1 is installed in the “3F F zone” having the smallest reception angle.

Note that, although it has been described in FIGS. 21 to 23 that a plurality of installation positions corresponding to the reception angles are registered in the remote control system for each lighting ID of the lighting apparatus 1, for example, only one of installation position having the smallest reception angle may be registered in the remote control system.

In the present embodiment, for example, a process of updating (identifying) the installation position of the lighting apparatus 1 identified by the lighting ID in accordance with a change in the reception angle of the same lighting ID may be executed.

Furthermore, in the present embodiment, when the lighting ID transmitted from the control device 12 is received by the terminal device 11 in a wide range, an error between the position indicated by the position information of the terminal device and the actual installation position of the lighting apparatus 1 is likely to occur, and thus, for example, the reception range of the lighting ID (that is, the transmission intensity of the lighting ID, or the like) may be adjusted according to the layout of the building in which the plurality of lighting apparatuses 1 are installed, the arrangement of the plurality of lighting apparatuses 1, or the like.

Although the present embodiment has been described mainly on the assumption that the control device 12 and the control target device such as the lighting apparatus 1 are separately configured, the control device 12 may be incorporated in the control target device as described above with reference to FIG. 6. Only a part of the control device 12 may be incorporated in the control target device.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. These embodiments and modifications thereof are included in the scope and gist of the invention, and are also included in the invention described in the claims and the scope of equivalents thereof.

The functionality of the elements disclosed herein may be implemented using circuitry or processing circuitry which includes general purpose processors, special purpose processors, integrated circuits, ASICs (“Application Specific Integrated Circuits”), FPGAs (“Field-Programmable Gate Arrays”), conventional circuitry and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

The disclosure includes a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of a FPGA or ASIC.

What is claimed is:

1. A communication system comprising:
a plurality of control circuitries that are disposed in the vicinity of each of a plurality of devices and are configured to control each of the plurality of devices, and
a terminal that moves in a space in which the plurality of devices are installed and is configured to perform wireless communication with the plurality of control circuitries,
wherein:
each of the plurality of control circuitries transmits device identification information for identifying a device controlled by one of the control circuitries at a predetermined interval, and
the terminal acquires, when the device identification information transmitted from one of the control circuitries of the plurality of control circuitries is received, position information indicating a position of the terminal, and transmits the received device identification information and the acquired position information.

2. The communication system according to claim 1, wherein:
the wireless communication performed between each of the plurality of control circuitries and the terminal includes short-range wireless communication.

3. The communication system according to claim 1, wherein:
the terminal transmits the device identification information and the position information to a remote control system that remotely controls the plurality of devices, and
a correspondence relationship between the device identification information and the position information sent from the terminal is registered in the remote control system and used to remotely control the plurality of devices.

4. The communication system according to claim 3, wherein:
the terminal further transmits a signal reception strength or a reception angle when the device identification information is received, in addition to the device identification information and the position information.

5. The communication system according to claim 4, wherein:
the reception strength or the reception angle transmitted from the terminal is used to update the position information corresponding to the device identification information.

6. The communication system according to claim 1, wherein:
the terminal transmits user information for specifying a user who carries the terminal, instead of the position information indicating the position of the terminal.

7. The communication system according to claim 1, wherein:
each of the plurality of control circuitries periodically transmits sensor data measured by a sensor connected to one of the control circuitries together with the device identification information, and
the terminal transmits, when the device identification information and the sensor data transmitted from of the control circuitries among the plurality of control circuitries are received, the received device identification information and sensor data.

8. The communication system according to claim 1, wherein:
the position information is acquired by a position specifying function of the terminal.

9. The communication system according to claim 1, wherein:
the position information is acquired from a user management system that manages a position of a user, based on user information for identifying the user who carries the terminal.

10. The communication system according to claim 1, wherein:
the terminal periodically transmits device control data, and
each of the plurality of control circuitries controls the device so that the device operates and sets a time for which the device operates when the device control data is received.

11. The communication system according to claim 10, wherein:
each of the plurality of control circuitries controls the device so as to stop the operation of the device when the device control data is not received during a period from when a time for operating the device is set to when the time elapses.

12. The communication system according to claim 11, wherein:
each of the plurality of control circuitries sets the time for the device to operate again when the device control data is received during a period from when the time for the device to operate is set to when the time elapses.

13. A method, comprising:
transmitting, by a plurality of control circuitries, device identification information for identifying a device controlled by a corresponding one of the control circuitries at a predetermined interval,
acquiring, by a terminal, position information indicating a position of the terminal and transmitting the device identification information, which has been received from one of the plurality of control circuities, and the acquired position information when the terminal receives the device identification information transmitted from the one of the plurality of control circuitries.

14. The method according to claim 13, wherein:
the transmitting by the plurality of control circuitries includes short-range wireless communication.

15. The method according to claim 13, wherein:
the transmitting of the device identification information and the position information by the terminal transmits to a remote control system that remotely controls the plurality of devices, and
a correspondence relationship between the device identification information and the position information sent from the terminal is registered in the remote control system and used to remotely control the plurality of devices.

16. The method according to claim 15, further comprising:
transmitting, by the terminal, a signal reception strength or a reception angle when the device identification information is received, in addition to the device identification information and the position information.

17. The method according to claim 16, further comprising:
updating the position information corresponding to the device identification information using the reception strength or the reception angle transmitted from the terminal.

18. The method according to claim 13, further comprising:
transmitting, by the terminal, user information for specifying a user who carries the terminal, instead of the position information indicating the position of the terminal.

19. The method according to claim 13, further comprising:
periodically transmitting, by each of the plurality of control circuitries, sensor data measured by a sensor connected to the control circuitry together with the device identification information, and
transmitting, by the terminal, when the device identification information and the sensor data transmitted from one of the control circuitries are received, the received device identification information and sensor data.

20. The method according to claim 13, further comprising:
acquiring, by a position specifying function of the terminal, the position information.

21. The method according to claim 13, further comprising:
acquiring the position information from a user management system that manages a position of a user, based on user information for identifying the user who carries the terminal.
